(19) United States
(12) Patent Application Publication
(10) Pub. No.: US 2020/0261805 A1
(43) Pub. Date: Aug. 20, 2020

(54) SYSTEM, METHOD, AND DEVICE FOR PLAYING A DRINKING GAME

(71) Applicant: Boris MERTENS, Cologne (DE)

(72) Inventor: Boris MERTENS, Cologne (DE)

(21) Appl. No.: 16/794,081

(22) Filed: Feb. 18, 2020

(30) Foreign Application Priority Data
Feb. 18, 2019 (DE) 10 2009 001 180.5

(51) Int. Cl. A63F 13/80; A63F 13/218

(52) U.S. Cl. CPC A63F 13/80; A63F 2250/024; A63F 13/218

(57) ABSTRACT

The drinking game system includes a device adapted for measuring a time elapsed between taking off and landing of a beverage container therefrom. The device is configured to operate in different phases and continuously feed the time elapsed to a player terminal associated with the players and connected thereto via a network. The player terminal is configured to execute a program product that allows the players to enter into a gaming mode to connect the player terminal to the device, and provide user interfaces to the players for playing the drinking game, and feed device identification codes to the device for the players to identify the device connected to the player terminal associated with them.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention generally relates to drinking games. Particularly, the present invention relates to an improved drinking game device, system, and method enabled by a program product that provides one or more user interfaces to one or more players playing the drinking game.

### 2. Description of Related Art Including Information Disclosed Under 37 CFR 1.97 and 37 CFR 1.98

Social games such as drinking games are a favourite past time among people of all ages specifically among young adults. Drinking games are usually played by the people drinking alcohol or beer from a beverage container. Various drinking devices, and methods are known in the art that are either specifically used for playing a drinking game, or used for measuring how often a user drinks from such devices. A review of the related technologies revealed the following prior arts:

GB2392109 discloses an electronic game device suitable for playing a drinking game. As disclosed in the application, the device includes a drinking vessel for filling a liquid into it, and a support/mat for the drinking vessel on which the drinking vessel is placed and lifted up during the game. The mat houses various electronic components necessary for the functioning of the device such as a main switch, a central processing unit with a first timer and a second timer, a magnetically activated switch, a first light source, a display unit, a second light source, a speaker and a power source. As disclosed in the application, the first timer housed inside the device for measuring the time taken for drinking the liquid contained in the vessel during the game while the second timer is used as a countdown timer for performing a countdown before the start of the game. The magnetically activated switch used in the device serves as an activation and deactivation means, and the action of this magnetically activated switch is controlled by means of operating magnet embedded into the base portion of the drinking vessel.

U.S. Pat. No. 4,400,090 discloses about a timer device that can be used for a contest. As disclosed in the application, the device can be used to measure the shortest time required to perform two identical functions, firstly an act of removing an item such as a beverage vessel/container from a stand, secondly performing work with respect to the item such as drinking the beverage within the container, and returning the container back to the stand. As disclosed, the device includes optical sensing means for providing stop signals to a timing means in response to the return of the beverage container to the stand and providing an activating signal to a foul indicator when the beverage container is removed from the stand prior to the start of the contest.

DE102004004328 discloses a health related device. Particularly, the patent application describes a method and a device that reminds a user (especially who is engaged at work over computer for hours) for drinking of the water during different time intervals of the day ensuring sufficient water is consumed by the user for healthy living. The patent application discloses an apparatus that includes a holder for holding a bottle filled with water, a timer in the form of weighing device to automatically monitor a level of mineral water contained in the bottle kept over the apparatus. As disclosed, the bottle is used to drink from the holder and then placed back in the holder once the user consumes the water from the bottle. At regular time intervals a comparison between the elapsed time and the residual level of the water inside the bottle is carried out by the apparatus. As described, if the level of water in the bottle is found higher than a predetermined value then a reminder is sent to the user (using piezo transducer) to remind him/her about drinking the water.

WO2013128202 discloses about a drinking aid for reminding a user to take a drink at regular intervals. The aid includes a sensor that detects the state of the content in a beverage receptacle. The aid further includes a timer for measuring predetermined times for which the sensed states remain unchanged. The aid further includes a processor for processing signals from the sensor and the timer, and an alerting means for generating an alert for the user to remind him/her to drink from the receptacle.

Although, above listed prior art discloses various types of devices that can be essentially used or modified for use in a drinking game. None of these prior arts discloses a device, system and method for playing the drinking game, where the gaming system is enabled by a program product residing on a player terminal associated with the players playing the drinking game.

### BRIEF SUMMARY OF THE INVENTION

It is an objective of the present invention to provide a device, system and method for playing a drinking game, wherein the device, system and method are enabled by a program product that would provide one or more user interfaces over a player terminal of the players engaged in playing the drinking game.

Another objective of the present invention to provide a drinking game system and method that can provide more engaging experience to the player playing the drinking game or competing with other players in the game.

Another objective of the present invention to provide a drinking game system which would add more value to the drinking game over existing prior arts especially in today's world where lot of people prefer playing games over their mobile devices such as mobile phone, tablets.

Another objective of the present invention to provide a drinking game system and method that can be played by the players on various events that can be created and customized by the players as needed. The events may include but not limited to university and college parties, beach house parties and other festive occasions at which alcoholic beverages, such as beer, are present.

Another objective of the present invention is to provide a drinking game system enabled by a wirelessly connectable app configured on the one or more player's terminals that would facilitate the players perform various social media activities such as for example, organizing of various pubs/party events or online drinking game competitions among social friends, gaining fame in the social circle, sharing recorded drinking game videos and so on over different social platforms.

Another objective of the present invention is to provide a drinking game system enabled by a wirelessly connectable app configured on the one or more player's terminals, wherein the app could serve to act as advertising platform usable by various beverage manufacturers to advertise their beverages online.

Various embodiments of the present invention provide a drinking game system and method. The drinking game system includes a device adapted for measuring a time elapsed between taking off and landing of a beverage container therefrom by the players, wherein the device is configured to continuously feed the time elapsed (at different phases of the device's operations) to the player terminal associated with the players and connected thereto via a network, wherein the player terminal is configured to execute a program product that allows the players to enter into at least one gaming mode in order to connect the player terminal to the device, and wherein the execution of the program product further provides one or more user interfaces to the players, and feed one or more device identification codes to the device for the players to identify the device connected to the player terminal associated with them.

According to the embodiments, the device includes one or more controllers configured to read a status of a switch means at a specific time, and in response to reading the status, process and continuously feed the time elapsed between take-off and landing of the beverage container to a stop watch, and/or the player terminal connected thereto via the network, wherein the stop watch is further configured to visually display the status and the time elapsed.

According to the embodiments, the device further includes a plurality of Light-Emitting Diodes (LEDs), a power source for powering the controllers, the stop watch, and the LEDs, and a top cover, and a base wherein the top cover securely and hingedly covers the base including the switch means, the controller, the stop watch, the power source, and the LEDs.

According to the embodiments, the device identification codes are configured in the form of Red, Green, and Blue (RGB) codes and are used by the controllers for switching on the plurality of LEDs.

According to the embodiments, the user interfaces provided to the players over the player terminal further facilitates the players to manage one or more events at which the drinking game can be played, and manage participation of the players in the events.

According to the embodiments, the management of participation of the players includes at least one of: adding a new player, deleting the players, modifying a first set of information associated with the players, viewing a second set of information associated with the players, selecting the players to participate in the events to compete and play the drinking game. The first set of information includes at least one of: a name, a personal music, and a profile image associated with each of the players, and the second set of information includes at least one of: number of times each of the players played the drinking game, statistical information associated with each of the players, a ranking associated with each of the players, and a best performing time of each of the players.

According to the embodiments, the management of the events includes at least one of: adding a new event, deleting the events, viewing the events, and modifying a third set of information associated with the events. The third set of information includes at least one of: a name, an event related image, a class identifying size of the beverage container, and the players associated with each of the events.

According to the embodiments, the at least one gaming mode includes a solo player mode facilitating a player from the players to play the drinking game, and a multi-player mode facilitating at least two players to play the drinking game.

According to the embodiments, the user interfaces provided to the players over the player terminal further facilitates performing at least one of: recording a video, playing back the personal music to the players, and showcasing the time elapsed continuously fed by the controllers.

### BRIEF DESCRIPTION OF THE SEVERAL VIEWS OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings.

FIGS. 1-2 are schematic views of block diagrams that illustrate a system environment in which various embodiments of the present invention are practiced.

FIG. 3 is a schematic view illustrating a basic exemplary implementation of a player terminal and/or an application server, in accordance with exemplary embodiments.

FIG. 4 is a schematic view of a diagram of a device shown in an opened state, according to an exemplary embodiment of the present invention.

FIG. 5A-5D are perspective views illustrating different phases at which controllers housed inside the device would feed a time elapsed to a stopwatch, and a player terminal, according to an exemplary embodiment of the present invention.

FIG. 6 is a schematic view of an exemplary user interface that allows the players to enter into at least one gaming mode in order to connect the player terminal to the device for playing the game, according to an exemplary embodiment of the present invention.

FIGS. 7-9 are schematic views of exemplary user interfaces that allow the players to manage events at which the drinking game can be played, according to an exemplary embodiment of the present invention.

FIGS. 10-11 are schematic views of exemplary user interfaces that allow to manage participation of the players for the drinking game in a selected event, according to an exemplary embodiment of the present invention.

FIG. 12 is a schematic view of an exemplary user interface that allows selection and addition of the players to the drinking game in the selected event, according to an exemplary embodiment of the present invention.

FIGS. 13-14 are schematic views of exemplary user interfaces that allow the players to view a set of information associated therewith, and information associated with other participating players, according to an exemplary embodiment of the present invention.

FIG. 15 is a schematic view of an exemplary user interface that facilitates the players to record a video, listen to the personal music linked to their profile, and continuously view the time elapsed that's fed by the controllers to the player terminal during the drinking game, according to an exemplary embodiment of the present invention.

FIGS. 16-20 are schematic views of exemplary user interfaces associated with multi-player gaming mode that allow at least two players to play the drinking game or compete simultaneously, according to an exemplary embodiment of the present invention.

FIGS. 21-22 are schematic views of exemplary embodiments of the device of the game system of the present invention.

### DETAILED DESCRIPTION OF THE INVENTION

As used in the specification and claims, the singular forms “a”, “an” and “the” may also include plural references. For example, the term “a player” may include a plurality of players, “a device” may include a plurality of devices and so on. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a drinking game system and method associated thereof enabled by a program product that provides one or more user interfaces to one or more players playing the drinking game to provide more engaging experience to the players playing the drinking game or competing with each other in the game. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention. For the purpose of this invention, the terms “user”, “player” and so on are all interchangeably used in the following description. For the purpose of this invention, the terms “game”, “drinking game”, “game play” and so on are all interchangeably used in the following description.

References to “one embodiment”, “an embodiment”, “another embodiment”, “yet another embodiment”, “embodiments”, “an example”, “another example”, “yet another example”, “various embodiment” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” and so on used in this description are used to arbitrarily distinguish between the elements. Thus, these terms are not necessarily intended to indicate temporal or other prioritization of such elements.

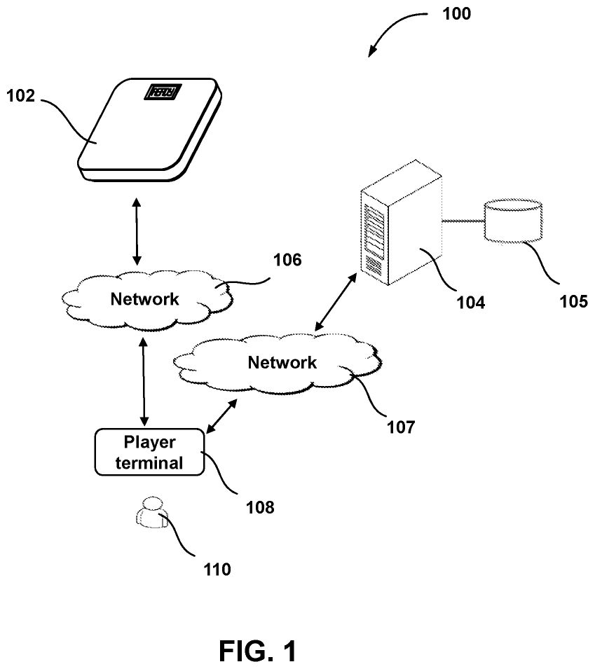

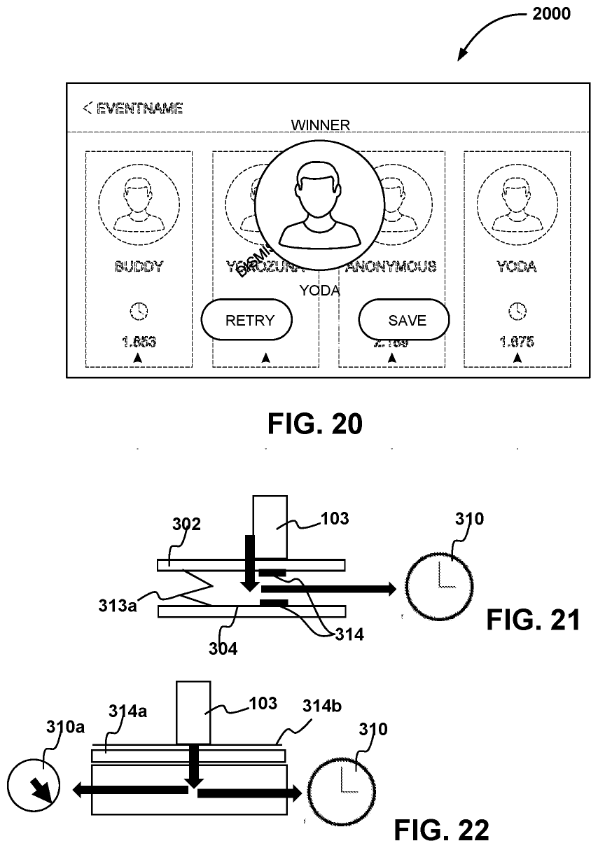

The present invention and various embodiments will now be described with reference to the accompanying drawings, specifically with respect to FIGS. 1-20.

Referring to FIG. 1, a system environment 100 is shown. The system environment 100 shows a single user or player 110 playing the drinking game. As shown in the FIG. 1, the system 100 essentially includes the player 110 playing the game, a player terminal 108 associated with the player 110, a time measuring device 102 (“hereinafter referred as “device”) for the player 110 to take off and land a beverage container (not shown) to and from the device 102 during the game. The system 100 further includes a network 106 for connecting the player terminal 108 with the device 102 when the player 110 participates in the game using the player terminal 108. The system 100 further includes an application server 104, one or more database servers such as a database server 105, and a network 107.

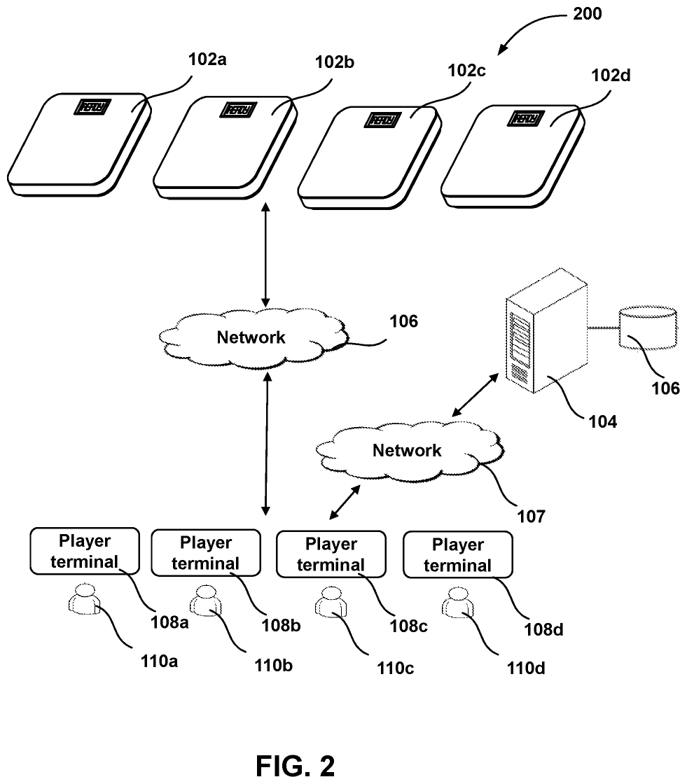

Referring to FIG. 2, a system environment 200 is shown. The system 200 shows multiple users/players 110a-110d playing the drinking game or competing with each other. As shown in the FIG. 2, the system 200 essentially includes the multiple players 110a-110d playing the game, multiple player terminals 108a-108d each associated with the players 110a-110d respectively, devices 102a-102d each associated with the players 110a-110d. The system 200 further includes the network 106 for connecting each of the player terminals 108a-108d with corresponding devices 102a-102d when the players' 110a-110d participate in the game using their player terminals 108a-108d. The system 200 further includes the application server 104, the database servers such as the database server 105, and the network 107. Although, according to an embodiment shown in the FIG. 2, four players 110a-110d are shown participating in the game, it should be understood that any number of the players can participate in the game in one go, such as one player, two players, three players, four players and so on.

The application server 104 shown in the FIGS. 1-2 is a computer, a software framework, or a combination thereof, that may provide a generalized approach to create the application server implementation. Although the present disclosure is explained by considering the system 100 or 200 is implemented using a program product hosted by the server 104 that the player 110 can install as a client app on his/her terminal 108, it may be understood that the system 100 or 200 may also be implemented in a variety of computing systems, such as a network server, cloud, and the like. Although, in the preferred embodiment, the player terminal 108 is configured to run a software program product as the client app hosted by the application server 104, it is also possible that the player terminal 108 may be configured to run a web application, hosted by the application server 104 that would allow the players 110 present globally to connect and perform the one or more operations online. Wherein such web based implementation of the presently disclosed invention, would facilitate the users with a new type of sport (e-sport) or IoT drinking game, effectively connect global community of party people.

The application server 104 may be realized through various web-based technologies such as, but not limited to, a Java web-framework, a .NET framework, a PHP (Hypertext Preprocessor) framework, or any other web-application framework. The application server 104 may operate on one or more operating systems such as Windows, Android, Unix, Ubuntu, Mac OS, or the like. The database server 105 may include suitable logic, circuitry, interfaces, and/or code, executable by the circuitry that may be configured to perform one or more data management and storage operations such as receiving, processing, and storing data or content. In an embodiment, the database server 106 may be a data management and storage computing device that is communicatively coupled to the application server 104 and/or the player terminal 108 using suitable communication network known in the art to perform the one or more operations. In an exemplary embodiment, the database server 106 may be configured to manage and store data related to the players 110, and the events. In an embodiment, the data related to the players 110 may preferably include but not limited to information related to the players 110 such as names of the players 110, personal music related to the players 110, profile images associated with the players 110, number of times the players 110 played the drinking game, statistical information associated with the players 110, rankings associated with the players 110, and best performing time of the players 110 in an event. In an embodiment, the data related to the events may preferably include but not limited to names of the events, events related images, classes identifying sizes of the beverage containers, and names of the players 110 associated with the events. In an embodiment, the database server 105 may be configured to receive a query from the application server 104 for retrieval of the stored information. Based on the received query, the database server 105 may be configured to communicate the requested information to the server 104. Examples of the database server 105 may include, but are not limited to, a personal computer, a laptop, or a network of computer systems.

The network 106 or 107 may include suitable logic, circuitry, interfaces, and/or code, executable by the circuitry that may be configured to transmit messages and requests between various entities, such as the application server 104, the database server 105, the player terminals 108, and the devices 102. Examples of the network 106 or 107 include, but are not limited to, a wireless fidelity (Wi-Fi) network, a Bluetooth Low Energy (BLE) network, a satellite network, the Internet, a fiber optic network, a coaxial cable network, an infrared (IR) network, a radio frequency (RF) network, and combinations thereof. Various entities in the system environment 100 or 200 may connect to the network 106 or 107 in accordance with various wired and wireless communication protocols, such as Transmission Control Protocol and Internet Protocol (TCP/IP), User Datagram Protocol (UDP), Long Term Evolution (LTE) communication protocols, or any combination thereof.

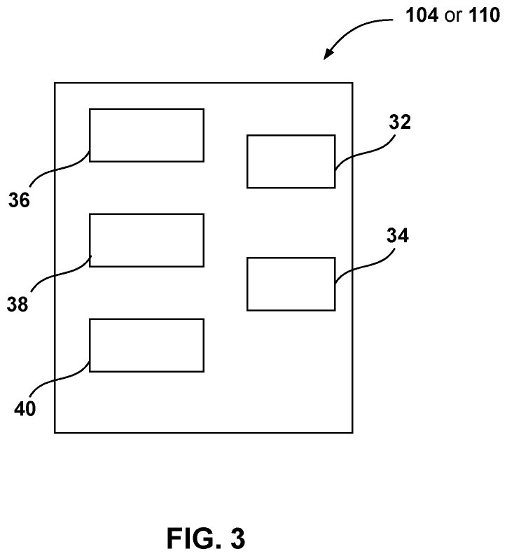

In accordance with an example implementation, as shown in FIG. 3, each of the player terminals 108a-108d (collectively referred as 108) and the server 104 may include one or more processors, such as a processor 32, one or more memory, such as memory 34, a transceiver 36, one or more I/O interfaces, such as an I/O interface 40 and a display 38.

The processor 32 may be communicably coupled with the transceiver 36 to receive signals from the server 104. Further, the transceiver 36 may be configured to transmit signals generated by the processor 32. The processor 32 is in communication with the memory 34, wherein the memory 34 includes program modules such as routines, programs, firmware, objects, components, data structures and the like, which perform particular tasks to be executed by the processor 32.

The player terminal 108 may be connected to other information processing devices by using the I/O interface 40. The display 38 may be utilized to receive inputs (over user interfaces) from the player 110 using the player terminal 108 or may be utilized for displaying various user interfaces to the player 110. The I/O interfaces 40 may include a variety of software and hardware interfaces, for instance, interface for peripheral device(s) such as a keyboard, a mouse, a scanner, an external memory, a printer, LCD tv screens and the like. In an embodiment, the processor 32 may include different types of processors known in the art including neural network-based algorithms that are effectively used in several applications.

The player terminals 108 may include but not limited to a mobile phone, a desktop computer, a laptop computer, a workstation, a personal digital assistant (PDA), or other device that may communicate data via the network 106 or 107 and may display information to the players 110 over the user interfaces (UIs).

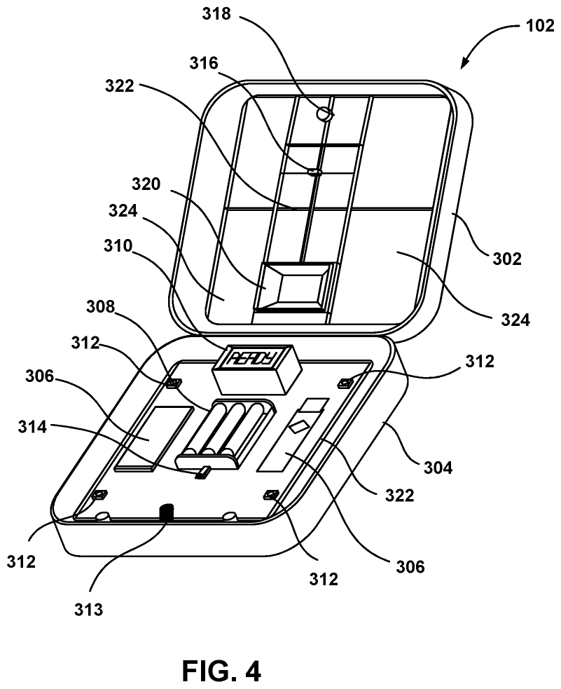

Referring to the FIG. 4, a schematic diagram of a device is shown in an opened state, according to an exemplary embodiment of the present invention. The device 102 is adapted for measuring a time elapsed between taking off and landing of the beverage container to and from the device 102 by the players 110. The device 102 is further configured to operate under different phases and continuously feed the time elapsed to the player terminal 108 associated with the players 110 and connected thereto via the network 106. As seen in the FIG. 4, the device 102 includes one or more controllers 306 configured to read a status of a switch means 314 at a specific time, and in response to reading the status, process and continuously feed the time elapsed between take-off and landing of the beverage container to a stop watch 310. The stop watch 310 is configured to visually display the status and the time elapsed to the player 110 via a display window 320 on top cover 302 of the device 102.

The device 102 further includes a plurality of Light-Emitting Diodes (LEDs) 312 such as ws2812b. Although, in the embodiment described herein there are four LEDs 312 used, it should be understood that any number of LEDs 312 can be used. The device 102 further includes a power source 308 such as for example batteries for powering various electronic components, such as the controllers 306, the stop watch 310, and the LEDs 312. The LEDs 312 are switched on or off based upon the operation of the program product installed on the player terminal 108 of the players 110.

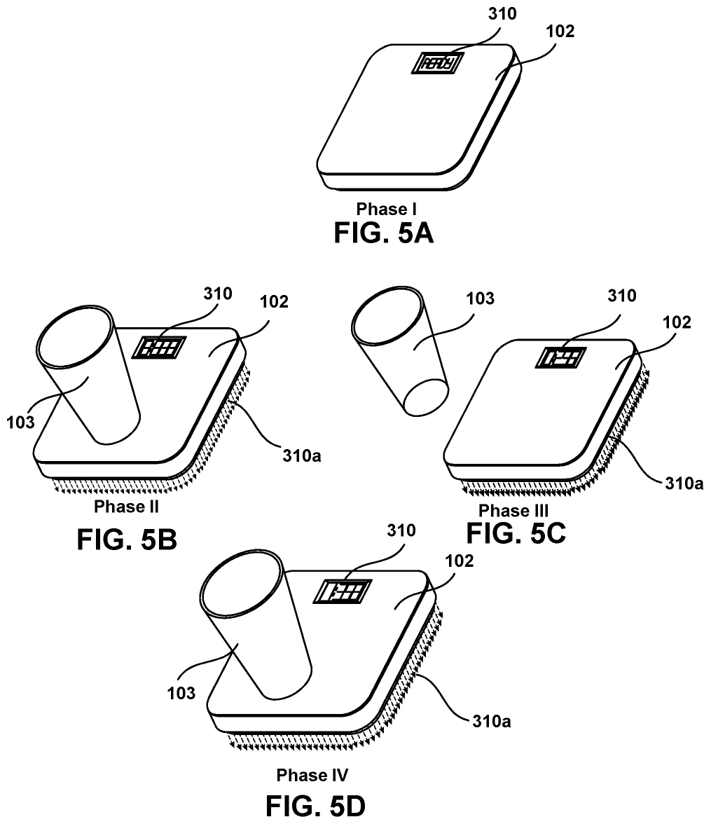

The device 102 further includes the top cover 302, and a base 304. The top cover 302 is configured to securely and hingedly cover the base 304. The device 102, particularly the top cover 302 and the base 304 are made using suitable material that can provide greater strength and durability to the device 102. In an example, the top cover 302 and the base 304 may be provided with a plurality of ribs 322 distributed internally thereon to provide added strength and stability to the device 102 against any accidental smashing of the beverage container on the device 102 when the participating players land the beverage glass all of a sudden over the device 102. According to an embodiment, the device 102 is configured in a way such that there is a small gap formation between the top cover 302 and the base 304 when the device 102 is in closed state. Further, the top cover 302 may be provided with reflecting tape or spray internally covering the inner surface in order to reflect the light of the LEDs 312 such that the optimum amount of light from the LEDs 312 can come out of the device 102 through the small gap in the form of a shiny rim 310a on an under surface of the device 102 as shown in the FIGS. 5B-5D

According to the embodiment, the display window 320 configured on the top cover 302 is sealed by an acrylic glass plate to prevent any splashing liquids over the device 102 to get into the device 102 that may in turn damage the electronics contained therein.

The controllers 306 housed inside the device 102 would feed the time elapsed to the stop watch 310, and the player terminal 108 at different phases/modes of operations using the network 106 or any other networks known in the art. Referring to the FIGS. 5A-5D in conjunction with the FIG. 4, the controllers 306 housed inside the device 102 feed the time elapsed to the stop watch 310 at different phases, namely Phase I, Phase II, Phase III, and Phase IV.

Phase I: Technically, at this stage, the device 102 remains closed in a relaxed state/a reset state. At this stage, a nose 316 configured internally on the top cover 302 of the device 102 remain at a close proximity to the switch means 314 without activating the switch means 314. Also, at this phase, a spring 313 actually provided to uplift the top cover 302 (by push action on a stud 310 provided on the top cover 302) during the game remain in a relaxed state without experiencing any tension. At this phase, the stop watch 310 displays “READY”. It is the phase at which the beverage glass/container 103 is not placed over the device 102 and the game is not initiated.

Phase II: Technically, at this stage, the device 102 remains closed with the switch means 314 activated. At this stage, the nose 316 gently pushes the switch means 314 to activate the switch means 314. Also, at this phase, the spring 313 is compressed with the weight of the beverage container 103 containing the alcoholic beverage thereby creating the tension. At this phase, the stop watch 310 displays “0,000”. It is the phase at which the drinking game is about to begin or SET to go.

Phase III: Technically, at this stage, the device 102 remains closed with the switch means 314 deactivated again. At this phase, the spring 313 relaxes again and pushes the top cover 302 upward. At this stage, the nose 316 again comes in the close proximity to the switch means 314 without actually activating the switch means 314. At this phase, the time starts running until the player lands the beverage container back on the device 102. Although, the stop watch 310 is shown displaying “0:235” as time, it can actually be any time before the player 110 lands back the beverage container 103 over the device 102. It is the phase at the drinking game is in action (countdown is going) and the player 110 is consuming beverage from the beverage container 103.

Phase IV: Technically, at this stage, the device 102 remains closed with the switch means 314 activated again just like the Phase I. At this stage, the nose 316 gently pushes the switch means 314 to again activate the switch means 314. Also, at this phase, the spring 313 is compressed again with the weight of the beverage container 103 alone or with the weight of the beverage container 103 containing leftover alcoholic beverage thereby creating the tension again in the spring 313. Although, the stop watch 310 is shown displaying “1:358” as time, it can actually be any time based on how soon the player 110 lands back the beverage container 103 over the device 102 after consumption of the beverage. It is the phase at which a cycle of the drinking game comes to an end and the players if want can either save the outcome results or retry the game.

The device 102 can be made to enter into the phase I to start the game again, by pressing the top cover 302 twice that makes the nose 316 push/click on the switch means 314 twice.

Although, according to the embodiment, the device 102 alone can be used by the players 110 to play the game, where that the players 110 can view the time lapsed or different phases of the game play on the stop watch 310 directly, it is preferred that the players 110 with the player terminal 108 connect to the device 102 using the network 106 such as BLE or wifi to get an engaging experience of playing the game using the player terminal 108.

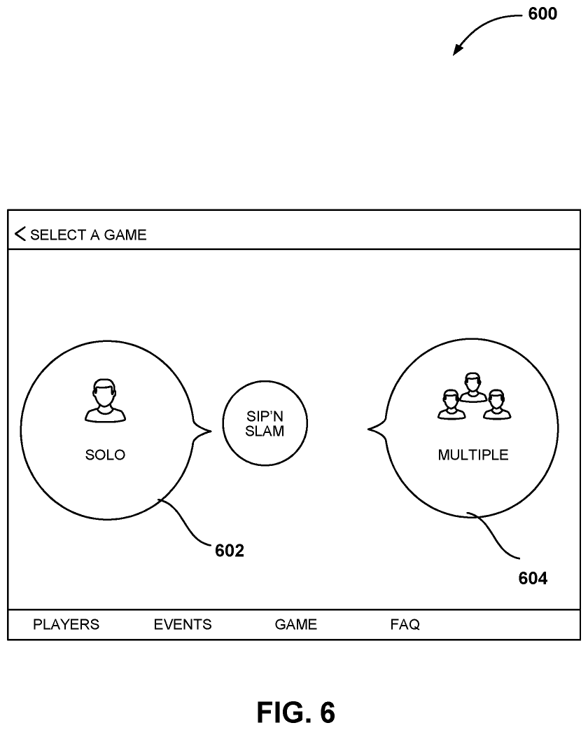

In operation, once the players 110 have the program product (in the form of the client app) installed on the player terminal 108, the players 110 are provided with a user interface 600 as shown in the FIG. 6. The user interface 600 allows the players 110 to enter into at least one gaming mode to establish the network connection 106 between the player terminal 108 and the device 102. Once the network connectivity 106 is established between the player terminal 108 and the device 102, the player terminal 108 is able feed one or more device identification codes to the device 102 for enabling the players 110 to identify the device 102 corresponding to the player terminal 108. The device identification codes are preferably configured in the form of some Red, Green, and Blue (RGB) codes, and once these RGB codes are received by the controllers 306 of the device 102, the controllers 306 can use the codes for switching on the LEDs 312. The RGB codes may correspond to the LEDs 312 emitting red, yellow, blue, green colours. The emitted light from the LEDs 312 come out of the device 102 through the small gap between the top cover 302 and the base 304 in the form of the shiny rim 310a visible at the under surface of the device 102 as shown in the FIGS. 5B-5D. Thus, different players 110 playing the game may be assigned different colours thereby differentiating the devices 102 corresponding to them based on the RGB codes transmitted from their player terminal 108 to the device 102. As seen in the FIG. 6, the gaming mode may include a solo player mode 602 that would facilitate a player from the players 110 to play the drinking game, and a multi-player mode 604 that would facilitate at least two players from the players 110 to play the drinking game.

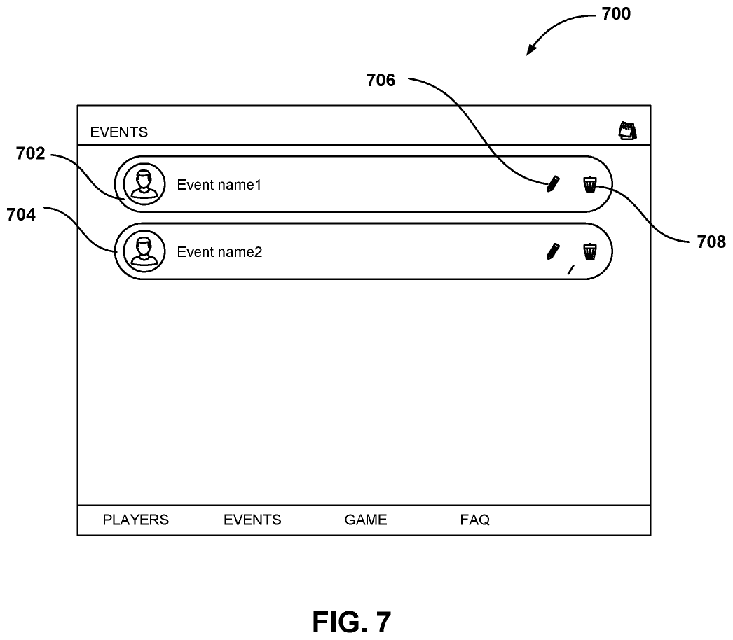

Once the players 110 enter into one of the gaming modes 602 or 604, the players 110 are then provided with various other user interfaces over the player terminal 108 that would allow the players 110 to manage various events at which the drinking game can be played. Different types of events may include but not limited to college parties, beach house parties and other festive occasions and so on at which alcoholic beverages, such as beer are consumed by people. The various user interfaces that would allow the players 110 to manage the various events are shown in the FIGS. 7-9.

As seen in the FIGS. 7-9, the management of various events preferably refers to adding of new events, editing any existing event related details, deleting any existing events, managing participation of the players in any selected events and so on. Particularly, the FIG. 7 shows a user interface 700, where the players/users 110 can view list of all the existing events such as events event name1 702, event name2 704 listed for exemplary purpose. If required the players can either edit 706 or delete 708 the selected event from the list presented to the players 110.

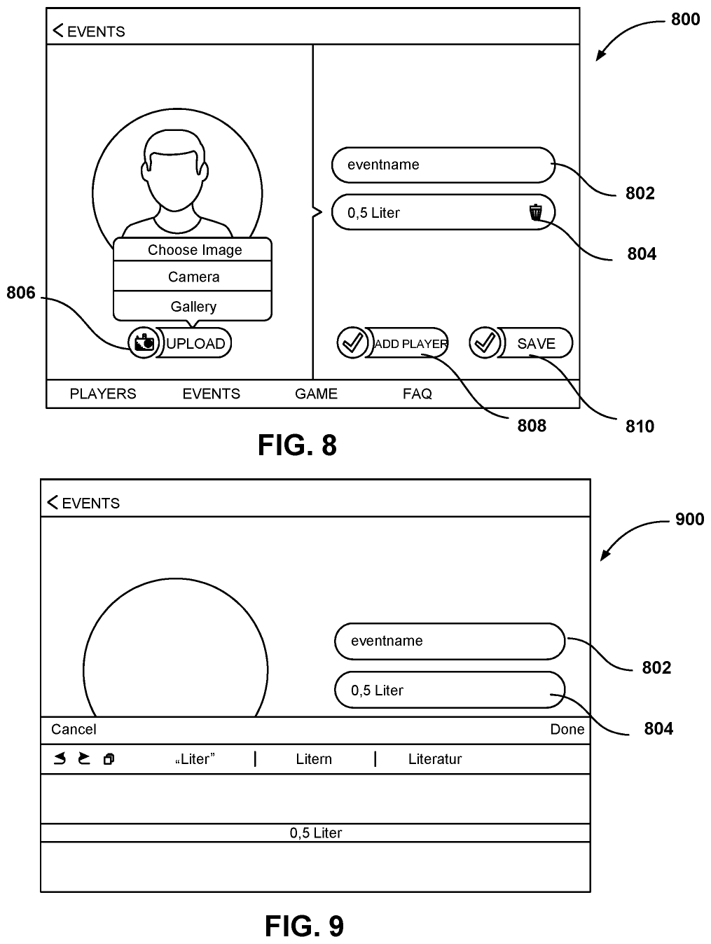

Referring to the FIGS. 8-9, user interfaces 800 and 900 are shown that allow the players 110 to add a new event or update/modify an existing event details. As seen, the players 110 can enter new event name or change an existing event name using a tab 802. For the specific event name that's added by the players 110, the players 110 can also add a class using a tab 804. The class 804 identifies size of the beverage container that the players 110 would be using during the game for filling and consuming the beverage. In an example, the class might correspond to 0.5 liter. As seen, the players 110 can upload a new event related image or replace existing event related image using a tab 806. The players 110 can upload the image from either the player terminal's gallery or choose to take a new image using the inbuilt camera feature. Further, as seen, the players 110 can also add new players to a chosen event using the tab 808, and then save all the updates and changes using a tab 810.

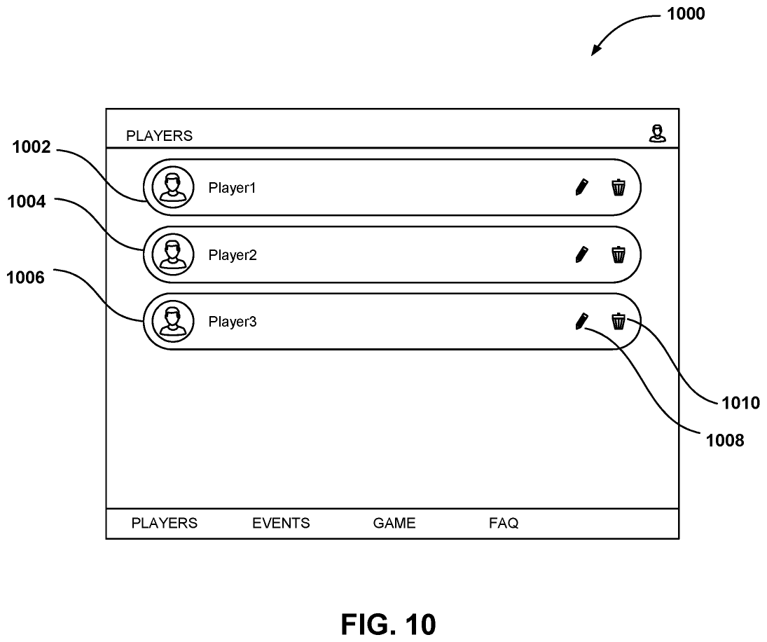

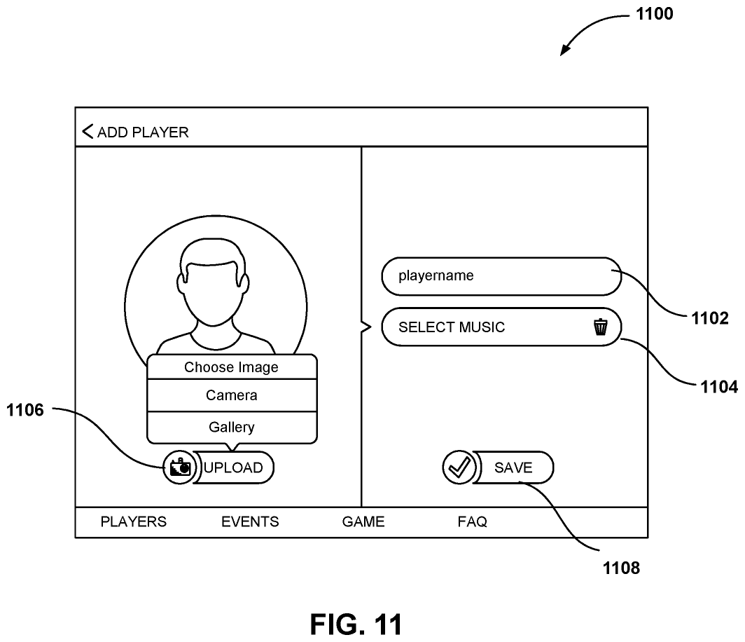

Referring to the FIGS. 10-11, exemplary user interfaces that allow to manage participation of the players 110 for the drinking game is shown. The management of participation of the players 110 refers to adding of new players, editing any existing player related details, deleting any existing players and so on. As seen, the user interface 1000 allows the players 110 to view a list of all the existing players such as player1 1002-player3 1006 listed for exemplary purpose. If required any selected player's details can be modified 1008 or any player can be deleted 1010 from the list presented for viewing. The FIG. 11 in particular shows addition of new player or modification of existing player related details. As seen, new player's name can be entered or existing player's name can be modified using a tab 1102. Further, for the added player, a personal music can be linked to his/her profile using a tab 1104. Further, a new profile image can be added or an existing profile related image can be replaced using a tab 1106. The profile images can be uploaded either by using the player terminal's gallery or can be instantly taken using the inbuilt camera feature provided by the program product installed on the player terminal 108. Further, all the entered detailed or modified details can be saves using a tab 1108.

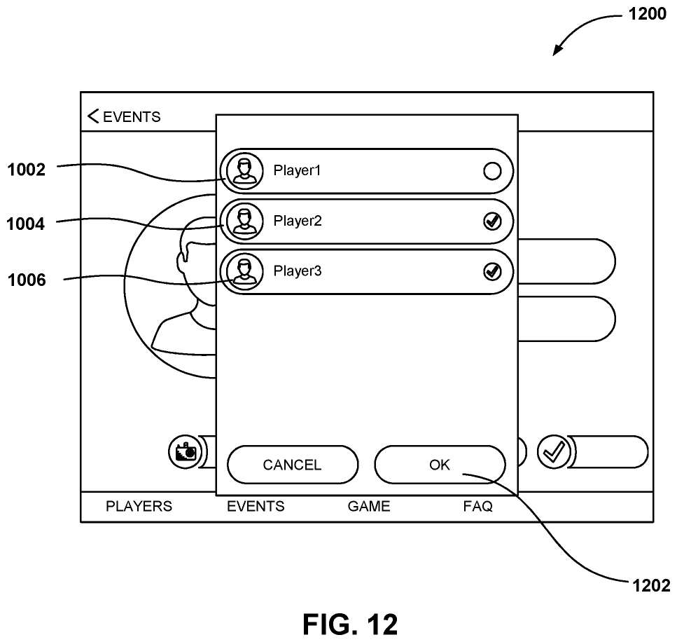

Referring to the FIG. 12, an exemplary user interface 1200 for selection and addition of the players to the selected event for playing the game is shown. Referring to the FIG. 12 in conjunction with the FIG. 8, as described with respect to the FIG. 8, the players 110 can add new players to a chosen event using the tab 808. Once the players 110 clicks on the tab 808, the players 110 are presented with the list of players such as player1 1002-player3 1006 to select the desired players and add them to the selected event to play the game. In the example shown, the desired players selected from the list of players player1 1002-player3 1006 include player2 1004 and player3 1006.

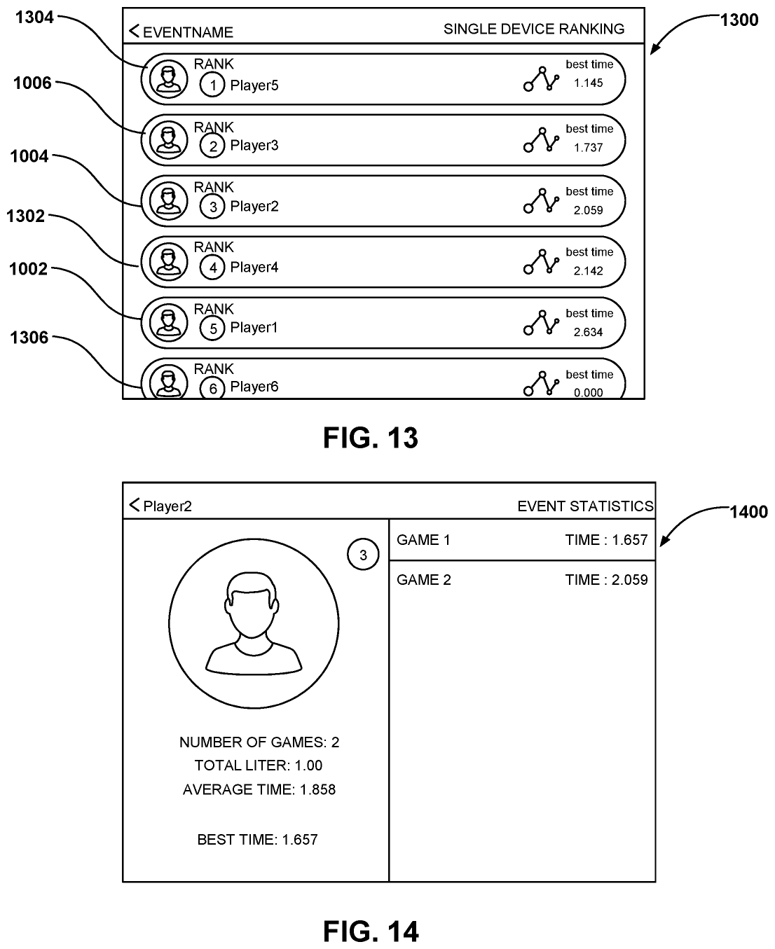

Referring to the FIGS. 13-14, exemplary user interfaces 1300 or 1400 show a set of information associated with the players player1 1002-player3 1006, and information associated with other participating players player4 1302-player6 1306. The set of information associated with the players' player1-player6 may include but not limited to the name of the players, the personal music, the profile image associated with each of the players, number of times each of the players played the drinking game, statistical information associated with each of the players, a ranking associated with each of the players, and a best performing time of each of the players. The statistical information may include but not limited to number of times the player has played the game in the selected event, total volume of the beverage consumed by the player in the specific game, an average time performance considering all the games he/she played, and the best time performance. For example, as shown in the FIG. 14, for the selected player such as player2, the statistical information that's shown are: number of times the player2 played the game in the selected event as 2, total volume of the beverage consumed by the player2 in the event as 1 liter, an average time performance considering all the games the player2 played as 1.858 sec, and the best time performance as 1.657 sec in the game 1 the player2 played in the selected event.

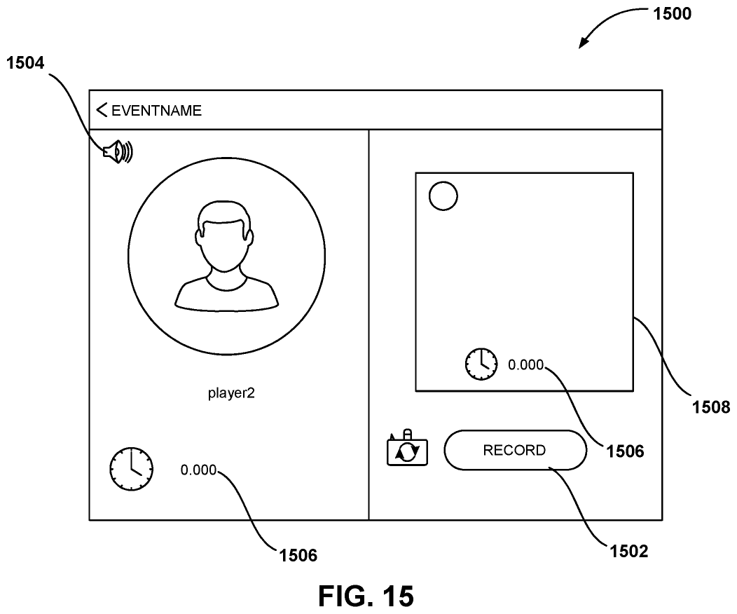

Referring to the FIG. 15, an exemplary user interface 1500 that facilitates the players 110 to record a video, listen to the personal music linked to their profile, and continuously view the time elapsed that's fed by the controllers to the player terminal during the drinking game is shown. Once the player 110 enters in one of the game modes, say for example solo player mode 602, the player terminal 108 gets auto connected to the device 102 with the specific colour (yellow for example) assigned to the player terminal 108 to identify the device 102. The player 110 can then select any specific event to play in, and then land and lift the beverage container 103 to and from the device 102 to play the game. As shown in the interface 1500, the player 110 during the game play can record 1502 a video, play back 1504 the personal music linked to the player's profile 110, and showcase the time elapsed 1506 continuously fed by the controllers 306 on the interface 1500. In an example, the time elapsed 1506 may be shown overlaid on the video recording screen 1508 or below the profile image of the player 110.

According to the embodiments, the recorded videos could be shared by the players 110 over various social media platforms. Besides that, the program products installed on the player terminal 108 would facilitate the players 110 to perform many other social media activities such as for example, organizing of various pubs/party events or online drinking game competitions among social friends and so on. Another to other embodiments, the wirelessly connectable app configured on the player terminals 108 would serve to act as advertising platform that could be used by various beverage manufacturers to advertise their beverages online.

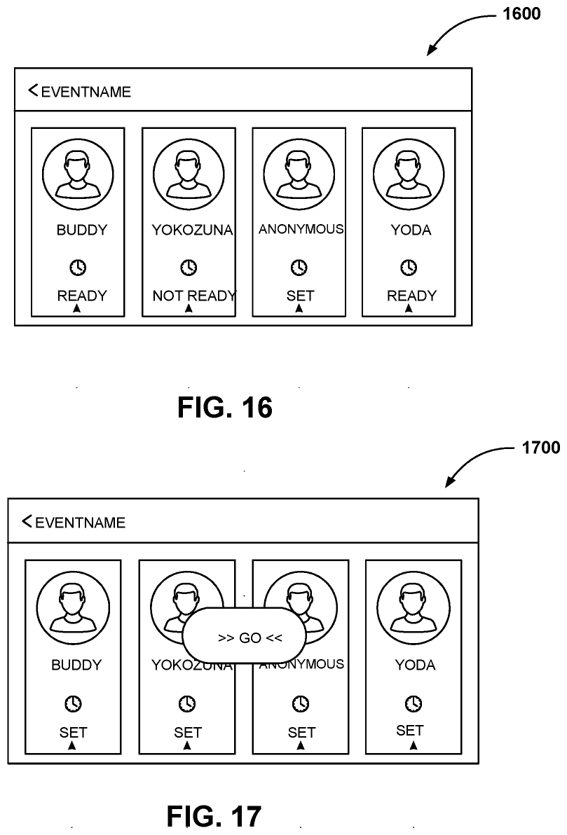

Referring to the FIGS. 16-20, exemplary user interfaces associated with multi-player gaming mode that allow at least two players to play the drinking game or compete simultaneously is shown. Although the user interfaces 1600-2000, shows participation of four players 110 in the game for a selected event, it should be understood that scope of present invention is not limited to number of players competing or playing the game, any number of players can compete or play at the same time. The FIG. 16 shows different phases of the devices 102 each linked to the players, namely Buddy, Yokozuna, Anonymous, and Yoda through the network 106. As shown in the FIG. 16, initially when the players enter into the game, the device 102 associated with the players may not be in the same phase, such as the device 102 related to Buddy is shown to be the phase I, showing “READY” on the stop watch and the interface 1600. Likewise, the device 102 related to Yokozuna is shown to be in the phase III or IV, showing “NOT READY” status on the interface 1600, the device 102 related to Anonymous is shown to be in the phase II showing “SET” status on the interface 1600, and the device 102 related to Yoda is shown to be in the phase I showing “READY” status on the interface 1600.

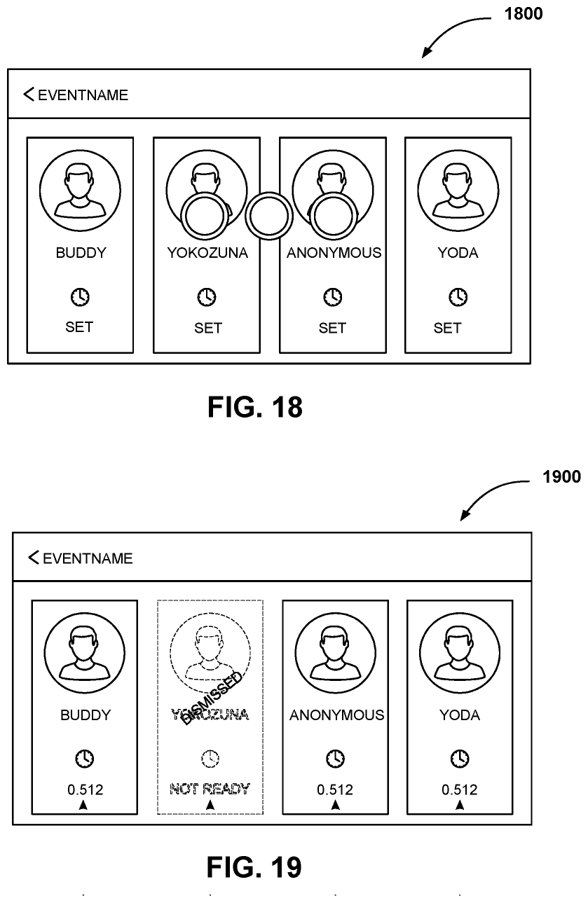

In order to play the game, the players are needed to reach the phase II (“SET” phase) at the same time, thus if the players are found to be in other phases, all the participating players wait for all of the players to be in the phase II, and once the participating players are in the phase II (“SET” phase) as shown in the FIG. 17, they click on the GO/start button to start the countdown process as shown in the FIG. 18, and if any player is found to lift the beverage container 103 from the device 102 before the countdown process ends then that specific player is dismissed from the game as shown in the FIG. 19. In the example, the player (Yokozuna) is shown dismissed from the game and the game continues with other remaining players lifting the beverage containers for consumption of the beverage and time keeps running for the remaining players, namely Buddy, Anonymous, and Yoda as shown in the example. Following countdown process, as soon as any player land the beverage container associated with him/her over the device 102, the game ends and the winning player name is announced with the option to save the game results, and to retry the game again.

In another embodiment, alternatively to or in combination with using the mechanical components (top cover 302, base 304, spring 313a, switch 314) to check the lift off and landing of the beverage, the device comprises a pressure sensor 314a triggering the switch 314.

In particular, the device has a waterproofed/robust box with the electronics (microcontroller, batteries, wireless modules) inside, a pressure sensor 314a on top of the box and preferably a cover/rubber layer 314b to protect the sensor from mechanical damage (by smashing a beverage on it). The pressure sensor 314a reacts on mechanical pressure (e.g. caused by placing a beverage on it) by changing the electrical resistance.

Alternatively to or in combination with activating the timer/stop watch 310, the pressure sensors also allows to measure the weight of a beverage, depending on the amount of force/resistance performed to it, which offers more possibilities of playing the game . . . like checking how much liquid remains in the beverage.

The preceding description has been presented with reference to various embodiments. Persons skilled in the art and technology to which this application pertains will appreciate that alterations and changes in the described structures and methods of operation can be practiced without meaningfully departing from the principle, spirit and scope of the present invention.

1. A drinking game system, comprising:
a device for measuring a time elapsed between taking off and landing of a beverage container therefrom by one or more players, wherein the device is configured to operate in one or more phases of operations and continuously feed the time elapsed to a player terminal associated with the players and connected thereto via a network,
wherein the player terminal is configured to execute a program product that allows the players to enter into at least one gaming mode and connect the player terminal to the device, and
wherein the execution of the program product the player terminal provide one or more user interfaces to the players, and feed one or more device identification codes to the device for enabling the players to identify the device connected to the player terminal associated therewith.

2. The drinking game system of claim 1,
wherein the device comprises:
one or more controllers configured to read a status of a switch means at a specific time, and in response to the read status process and continuously feed the time elapsed between take-off and landing of the beverage container to a stop watch, and the player terminal connected thereto via the network, wherein the stop watch is configured to visually display the status and the time elapsed;
a plurality of Light-Emitting Diodes (LEDs);
a power source for powering the controllers, the stop watch and the LEDs; and
a top cover, and a base wherein the top cover securely and hingedly covers the base including the switch means, the controller, the stop watch, the power source, and the LEDs.

3. The drinking game system of claim 1, wherein the device identification codes are configured in the form of Red, Green, and Blue (RGB) codes and are used by the controllers of the device for switching on the LEDs.

4. The drinking game system of claim 1,
wherein the one or more phases of operations comprise:
phase I of operation indicating the drinking game is not initiated;
phase II of operation indicating the drinking game is set to begin;
phase III of operation indicating the drinking game is undergoing a countdown process; and
phase IV of operation indicating an end of a cycle of the drinking game.

5. The drinking game system of claim 1, wherein the user interfaces provided to the players over the player terminal facilitates the players to manage one or more events at which the drinking game can be played, and manage participation of the players in the events.

6. The drinking game system of claim 5, wherein the management of participation of the players comprises at least one of: adding a new player, deleting the players, modifying a first set of information associated with the players, viewing a second set of information associated with the players, selecting the players to participate in the events to compete and play the drinking game.

7. The drinking game system of claim 6,
wherein the first set of information comprises at least one of: a name, a personal music, and a profile image associated with each of the players, and
wherein the second set of information comprises at least one of: number of times each of the players played the drinking game, statistical information associated with each of the players, a ranking associated with each of the players, and a best performing time of each of the players.

8. The drinking game system of claim 5, wherein the management of the events comprises at least one of: adding a new event, deleting the events, viewing the events, and modifying a third set of information associated with the events.

9. The drinking game system of claim 8, wherein the third set of information comprises at least one of: a name, an event related image, a class identifying size of the beverage container, and the players associated with each of the events.

10. The drinking game system of claim 1, wherein the at least one gaming mode comprises a solo player mode facilitating a player from the players to play the drinking game, and a multi-player mode facilitating at least two players from the players to play the drinking game.

11. The drinking game system of claim 1, wherein the user interfaces provided to the players over the player terminal further facilitates performing at least one of: recording a video, playing back the personal music to the players, and showcasing the time elapsed continuously fed by the controllers.

12. The drinking game system of claim 1, wherein the user interfaces provided to the players over the player terminal further facilitates the players to perform one or more social media activities.

13. The drinking game system of claim 1, further comprising: a program product.

14. The drinking game system of claim 1, wherein the player terminal is selected from the group consisting of: a mobile phone, a desktop computer, a laptop computer, a workstation, and a personal digital assistant (PDA).

15. The drinking game system of claim 1,
wherein the device comprises:
a top cover;
a base;
a spring provided to uplift the top cover relatively to the base; and
switch means connected to the top cover and the base;
wherein, when the spring (313) uplifts the cover, the switch means are not activated,
wherein, when the spring is compressed, the switch is activated, and
wherein the status of the switch means enabling to measure a time elapsed between taking off and landing of a beverage container from push action is provided on the top cover.

16. The drinking game system of claim 15, wherein the device further comprises: a timer and a pressure sensor configured to start/stop the timer.

17. A drinking game device for measuring a time elapsed between taking off and landing of a beverage container therefrom, the device comprising:
a top cover;
a base;
a spring provided to uplift the top cover relatively to the base; and
switch means connected to the top cover and the base;
wherein, when the spring uplifts the cover, the switch means are not activated,
wherein, when the spring is compressed, the switch is activated, and
wherein the status of the switch means enabling to measure a time elapsed between taking off and landing of a beverage container from push action is provided on the top cover.

18. The drinking game device of claim 17, further comprising: a timer and a pressure sensor configured to start/stop the timer.
